(19) United States
(12) Patent Application Publication
(10) Pub. No.: US 2019/0197018 A1
(43) Pub. Date: Jun. 27, 2019

(54) DYNAMIC RECONFIGURATION USING DATA TRANSFER CONTROL

(71) Applicant: Wave Computing, Inc., Campbell, CA (US)

(72) Inventors: Keith Mark Evans, San Jose, CA (US); Christopher John Nicol, Campbell, CA (US); Mehran Ramezani, Laguna Niguel, CA (US)

(21) Appl. No.: 16/289,814

(22) Filed: Mar. 1, 2019

Related U.S. Application Data
(63) Continuation-in-part of application No. 16/104,586, filed on Aug. 17, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.
(60) Provisional application No. 62/773,486, filed on Nov. 30, 2018.
(60) Provisional application No. 62/800,432, filed on Feb. 2, 2019.
(60) Provisional application No. 62/802,307, filed on Feb. 7, 2019.
(60) Provisional application No. 62/547,769, filed on Aug. 19, 2017.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06F 15/80; G06F 9/445; G06F 13/28

(52) U.S. Cl. CPC G06F 15/80; G06F 13/28; G06F 9/44505

(57) ABSTRACT

Techniques are disclosed for dynamic reconfiguration using data transfer control. Clusters on a reconfigurable fabric are accessed to implement a logical operation. The logical operation can include a Boolean operation, a matrix operation, a tensor operation, etc. Clusters from the plurality of clusters are provisioned for implementation of a first agent on the reconfigurable fabric. The clusters can include quads. The one or more clusters provisioned for the first agent include a first data transfer control block. Additional clusters from the plurality of clusters are provisioned for implementation of a second agent on the reconfigurable fabric. The additional clusters provisioned for the second agent include a second data transfer control block. The logical operation is performed using the first agent. Control information is transferred from the first data transfer control block to the second data transfer control block.

### RELATED APPLICATIONS

This application claims the benefit of U.S. provisional patent applications “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, and “FIFO Filling Logic for Tensor Calculation” Ser. No. 62/802,307, filed Feb. 7, 2019.

This application is also a continuation-in-part of U.S. patent application “Reconfigurable Fabric Data Routing” Ser. No. 16/104,586, filed Aug. 17, 2018, which claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to fabric reconfiguration and more particularly to dynamic reconfiguration using data transfer control.

### BACKGROUND

The emerging ability to collect vast amounts of data has enabled researchers, governments, and business people alike to analyze that data. These immense datasets, frequently referred to as “big data”, defy analysis using traditional techniques and processors, principally because such analysis overwhelms the capabilities of the systems and techniques previously used to handle large data. Further to data analysis, data capture, storage, maintenance, access, transmission, and visualization, etc., quickly exceed the capabilities of the traditional systems. Without a viable and scalable approach to address the needs and uses of the data, there would be little or no value to having it. Instead, radical processing techniques, algorithms, heuristics, and so on, are demanded. Those who own the datasets or have access to the datasets are eager to analyze the data contained therein. The analysis is performed for a variety of purposes including business analysis; disease detection, tracking, and control; crime detection and prevention; meteorology; complex science and engineering simulations, to name but a few. Advanced data analysis techniques, such as predictive analytics, are popular approaches to extracting value from the datasets for business and other purposes. Further uses for the datasets include machine learning and deep learning in support of the data analysis.

The sharply increased quantity of data collected by entities such as businesses, governments, and researchers quickly overwhelm the capabilities of traditional designs and architectures of processors, integrated circuits, and other computing hardware. Data is collected by the entities to meet objectives such as computation, research, learning, prediction, surveillance, and tracking. Big data, by definition and in fact, presents tremendous processing challenges because of the vast quantities of collected data. While the data handling and processing challenges are significant, the various entities that collect the data are highly motivated to process the data and to analyze the results. Data processing is performed for many commercial, research, and security applications such as learning, marketing, and predicting, among many others. Further to the processing, the analysis, capture, maintenance, storage, transmission, visualization, and so on, of the data saturate the processing and handling capabilities of the traditional systems. Instead, new processing hardware such as advanced computer chips and data handling architectures, and software based on advanced algorithms, heuristics, functions, and so on, are required. The success of the new approaches can be measured using computational metrics and other metrics. Further, the variety of the advanced hardware and software techniques support the rapid comparison of architectures and software to quickly identify the most promising options.

One highly promising architecture for processing large data sets, performing complex computations, and executing other applications is based on reconfigurability. Reconfigurable computing combines the desirable characteristics of both hardware and software techniques to its advantage. A reconfigurable computing architecture can be “recoded” (reprogrammed) to support a variety of computational approaches, much like software, while at the same time implementing an underlying high-performance hardware architecture. A reconfigurable fabric is one such architecture used for reconfigurable computing. Reconfigurable fabrics can be arranged in a variety of configurations or topologies, where the topologies are coded for the many applications that require high performance computing. Applications such as data processing of big data sets, digital signal processing (DSP), neural networks such as convolutional neural networks (CNN) and deep neural networks (DNN), matrix computations, tensor computations, and so on, are successfully served by the capabilities of a reconfigurable fabric. The capabilities of the reconfigurable fabric fare particularly well when the data can include specific types of data, large quantities of unstructured data, matrices, tensors, and the like. The reconfigurable fabrics can be coded or scheduled to realize these and other processing techniques. Further, the reconfigurable fabric can be scheduled to represent a variety of computer architectures that can perform computations more efficiently.

### SUMMARY

Reconfigurable computing includes architectures that incorporate a combination of circuit techniques and coding techniques. The hardware within the reconfigurable architectures is efficiently designed and achieves high performance when compared to the performance of general purpose hardware. Further, these reconfigurable architectures can be adapted or “recoded” based on techniques similar to those used to modify software. That is, the reconfigurable architecture can be adapted to a “new” architecture by changing the code used to configure the elements of the architecture. A reconfigurable computing architecture can be implemented using a reconfigurable processor fabric. The reconfigurable processor fabric can include computational or processor elements, storage elements, switching elements for data transfer, control elements, and so on. The reconfigurable fabrics are coded to implement a variety of processing topologies, many of which enable high performance computing. The many applications that can be supported by the reconfigurable fabric can include dynamic reconfiguration using data transfer control. The reconfigurable fabric can be configured by coding or scheduling the reconfigurable fabric to execute a variety of logical operations such as Boolean operations, matrix operations, tensor operations, mathematical operations, etc. The scheduling of the reconfigurable fabric can support a variety of computer architectures such as those used to perform logical operations with high efficiency. The scheduling of the reconfigurable fabric can be modified based on a data flow graph.

Dynamic reconfiguration uses data transfer control. The reconfigurable fabric includes a variety of “elements” such as processing elements, switching elements, storage elements, communications capabilities, and so on. Embodiments include a processor-implemented method for fabric reconfiguration comprising: accessing a plurality of clusters on a reconfigurable fabric to implement a logical operation; provisioning one or more clusters from the plurality of clusters for implementation of a first agent on the reconfigurable fabric, wherein the one or more clusters provisioned for the first agent include a first data transfer control block; provisioning one or more additional clusters from the plurality of clusters for implementation of a second agent on the reconfigurable fabric, wherein the one or more additional clusters provisioned for the second agent include a second data transfer control block; performing the logical operation using the first agent; and transferring control information from the first data transfer control block to the second data transfer control block.

In embodiments, the transferring control information from the first data transfer control block to the second data transfer control block occurs before the second agent is provisioned on the one or more additional clusters. In embodiments, the first data transfer control block and the second data transfer control block are common. In some embodiments, the transferring occurs when the first agent is not present. In other embodiments, the transferring occurs when the second agent is not present. And in yet other embodiments, each data transfer control block comprises a signal manager.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic reconfiguration using data transfer control.

FIG. 2 is a flow diagram for inter-agent communication.

FIG. 3 is a flow diagram for subgraph swapping.

FIG. 4 illustrates signal manager communication with an unloaded agent.

FIG. 5 shows signal manager fire/done forwarding.

FIG. 6 illustrates sending a fire signal to a distant agent.

FIG. 7 shows a fire and done signal transfer between distant agents.

FIG. 8 illustrates determining agent information from a buffer entry.

FIG. 9 shows a cluster for coarse-grained reconfigurable processing.

FIG. 10 shows a block diagram of a circular buffer.

FIG. 11 illustrates a circular buffer and processing elements.

FIG. 12 shows a deep learning block diagram.

FIG. 13 is a system for dynamic reconfiguration using data transfer control.

### DETAILED DESCRIPTION

Techniques are disclosed for dynamic reconfiguration of a reconfigurable fabric using data transfer control. A reconfigurable fabric can include one or more types of elements, such as processing elements, storage elements, switching elements, and so on. An element can be configured to perform a variety of architectural and computational tasks based on the type of element. The reconfigurable fabric can include quads or workgroups of elements, where the workgroups can include processing elements, shared storage elements, switching elements, circular buffers for control, communications paths, and the like. An element or subset of elements within the reconfigurable fabric, such as a quad of elements, can be controlled by providing code to one or more circular buffers. Code can also be provided to a plurality of elements within the reconfigurable fabric so that the reconfigurable fabric can perform various computational tasks such as logical operations, matrix computations, tensor operations, etc. The various elements of the reconfigurable fabric can be controlled using one or more rotating circular buffers. Functions, algorithms, instructions, codes, etc., can be loaded into a given circular buffer. The one or more circular buffers can be of the same length or of differing lengths. The rotation of the circular buffer ensures that the same series of coded steps or instructions is repeated as required by the processing tasks assigned to a processing element of the reconfigurable fabric. The one or more rotating circular buffers can be statically scheduled.

Dynamic reconfiguration of a reconfigurable fabric uses data transfer control. Clusters on a reconfigurable fabric are accessed to implement a logical operation. The clusters can include elements within the reconfigurable fabric such as processing elements. One or more clusters from the plurality of clusters are provisioned for implementation of a first agent on the reconfigurable fabric. The first agent can be part of a data flow graph. The one or more clusters provisioned for the first agent include a first data transfer control block. One or more additional clusters from the plurality of clusters are provisioned for implementation of a second agent on the reconfigurable fabric. The one or more additional clusters provisioned for the second agent include a second data transfer control block. A data transfer control block includes a signal manager which contains a table of control signals such as fire and done signals, first in first out (FIFO) pointers, and so on. The FIFO pointers and the done and fire signals enable direct memory access (DMA) transfer between provisioned clusters. The logical operation is performed using the first agent. The logical operation can include a matrix operation, a tensor operation, a Boolean operation, a mathematical operation, and so on. Control information is transferred from the first data transfer control block to the second data transfer control block. The agents associated with the data transfer control blocks need not be resident within the reconfigurable fabric. In embodiments, the transferring control information from the first data transfer control block to the second data transfer control block occurs before the second agent is provisioned on the one or more additional clusters. If the first agent or the second agent is not resident within the reconfigurable fabric when a transfer is to take place, then the control information is stored until the receiving agent is available to receive it. A fire signal can communicate from one agent to the next agent that data has been loaded and is available to be operated on by the next agent. Often, a length and sequence number is included as part of or in association with the fire signal. A fire signal can also communicate that pointers have been updated. The pointers can include an update for a write pointer, indicating the next location to be written. The pointers can include an update for a read pointer, indicating the next location to be read. A done signal can indicate that the data has been consumed by the next agent and that the memory where the data had been previously written is now ready to be overwritten. Thus, a fire signal and a done signal provide a handshake for data between two agents.

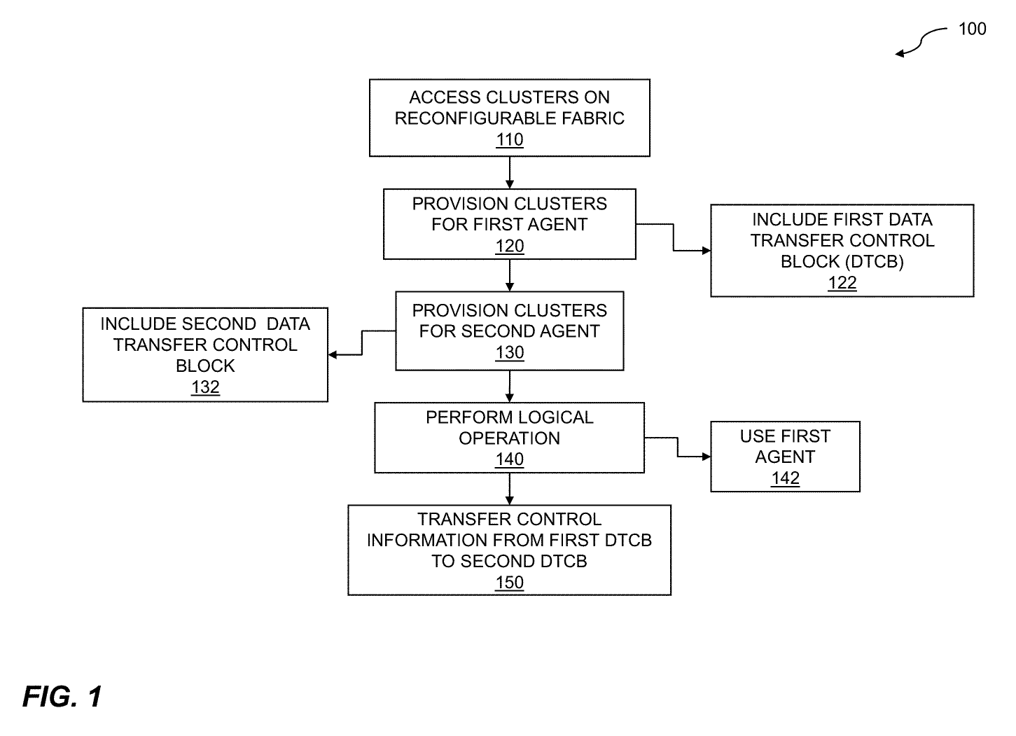

FIG. 1 is a flow diagram for dynamic reconfiguration using data transfer control. The flow 100 includes accessing a plurality of clusters on a reconfigurable fabric 110 to implement a logical operation. The logical operation can include a Boolean operation, a matrix, operation, a tensor operation, a mathematical operation, and so on. The clusters on the reconfigurable fabric can include various types of elements. In embodiments, each cluster from the plurality of clusters can include a plurality of processing elements. The clusters can include other elements such as storage elements, switching elements, and so on. In embodiments, the plurality of processing elements includes a quad of processing elements. The quad of processing elements can share resources such as control or storage resources. The quad of processing elements can include processing elements that can be in direct communication with each other. In embodiments, the reconfigurable fabric can include a plurality of circular buffers. The circular buffers can be programmed, coded, scheduled, etc., to configure the processing elements and other elements of the reconfigurable fabric. In embodiments, the circular buffers within the plurality of circular buffers can be statically scheduled. By statically scheduling the circular buffers, a set of instructions, for example, can be executed repeatedly and in the same order.

The implementation of the logical operation can include reconfiguring the reconfigurable fabric. The reconfiguration of the reconfigurable fabric can include loading instructions into rotating circular buffers, as discussed throughout. In embodiments, the fabric reconfiguration can be part of machine learning. The machine learning can be used to determine how to process various types of data, how to efficiently operate the reconfigurable fabric so as to execute a logical function, and so on. In embodiments, the fabric reconfiguration uses results of the machine learning. The machine learning can be used to determine how or when to load a data flow graph, swap in or swap out subgraphs of the data flow graph, load or unload agents from the data flow graph or subgraph, and the like. In embodiments, the results of the machine learning can include layers and weights within a neural network. A neural network can include input layers, output layers, hidden layers, bottleneck layers, etc. The weights can be applied to nodes within layers of the neural network. In embodiments, the neural network can include a convolutional neural network (CNN). A CNN can include a feed-forward network for processing data. In other embodiments, the neural network can include a recurrent neural network (RNN). The RNN can use connections that can form a directed graph, where the directed graph can be along a sequence. The RNN can base processing decisions on its internal state as it processes a given sequence.

The flow 100 includes provisioning one or more clusters from the plurality of clusters for implementation of a first agent 120 on the reconfigurable fabric. The clusters that are provisioned can include quads of processing elements, storage elements, switching elements, access to storage beyond the reconfigurable fabric such as DMA storage, and so on. The first agent can include an agent from a subgraph of a data flow graph, an entire data flow graph, etc. The first agent can be controlled by a rotating circular buffer that is statically scheduled. In embodiments, the one or more clusters provisioned for the first agent can include a first data transfer control block (DTCB) 122. The DTCB can include control signals such as fire signals or done signals, data, and the like. The flow 100 includes provisioning one or more additional clusters from the plurality of clusters for implementation of a second agent 130 on the reconfigurable fabric. The additional clusters that are provisioned can include additional processing elements, quads of processing elements, storage elements, switching elements, etc. The additional clusters can also be controlled by a rotating circular buffer. The rotating circular buffer can be the same rotating circular buffer as the one controlling the clusters provisioned for the first agent or it can be a different rotating circular buffer. In embodiments, the one or more additional clusters provisioned for the second agent include a second data transfer control block 132. The first agent and the second agent do not necessarily have to be from the same group of agents. In embodiments, the first agent is part of a first group of agents. The first agent can be provisioned independently from the second agent. In some embodiments, the second agent is part of a second group of agents. The subgraph of which the first agent is a part, or the subgraph of which the second agent is a part, can be swapped out of the reconfigurable fabric.

The first data transfer control block and the second data transfer control block can be either common or separate blocks. In embodiments, each data transfer control block comprises a signal manager. A signal manager can be used to manage fire signals, done signals, control signals, and so on. The signal manager can include tables, pointers, etc. In embodiments, the signal manager contains a table of done and fire signals. The fire signals can include fire signals from one or more agents associated with the signal manager. When a fire signal is forked from one agent to multiple agents, the signal manager can include a table entry for each receiving agent. In embodiments, the signal manager further includes FIFO pointers. A FIFO pointer can be used to point to data, signals, control signals, etc., that can be stored in a FIFO. The FIFO can be within the reconfigurable fabric or can be beyond the reconfigurable fabric. The pointers in the FIFO can be used to reference data from the output of one agent to be used at the input of a second agent. By passing a reference to the data rather than passing the data itself, a data transfer can be handled far more efficiently. In embodiments, the FIFO pointers and the done and fire signals can enable DMA transfer between the plurality of clusters and the one or more additional clusters.

The flow 100 includes performing the logical operation 140 using the first agent 142. As stated above, the logical operation can include a variety of operations such as a Boolean operation, a matrix operation, a tensor operation, or a mathematical operation. The operation can include executing an agent associated with a subgraph of the data flow graph, with the entire data flow graph, etc. The flow 100 includes transferring control information from the first data transfer control block to the second data transfer control block 150. The transfer typically includes signals such as fire signals and done signals. In some embodiments, the transfer could include data, agent information, buffer records, buffer entries, and so on. In embodiments, the transferring control information from the first data transfer control block to the second data transfer control block is accomplished when the second agent is not provisioned. In some cases, transfer is completed before the second agent is provisioned on the one or more additional clusters. In other cases, the transfer is completed after the second agent has been removed. The second agent may not be available to receive the transfer control information from the first agent if the second agent is not resident or has not been provisioned on one or more clusters of the reconfigurable fabric. In embodiments, the second agent is part of a second group of agents and a table of control information for the second group of agents retains the control information after the second group of agents has been vacated. In embodiments, the transferring can occur when the first agent is not present. In some cases, the transfer occurs before the first agent has been provisioned, while in other cases the transfer occurs after the first agent has been vacated. In many situations, both the first agent and the second agent are present during the transfer of control. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

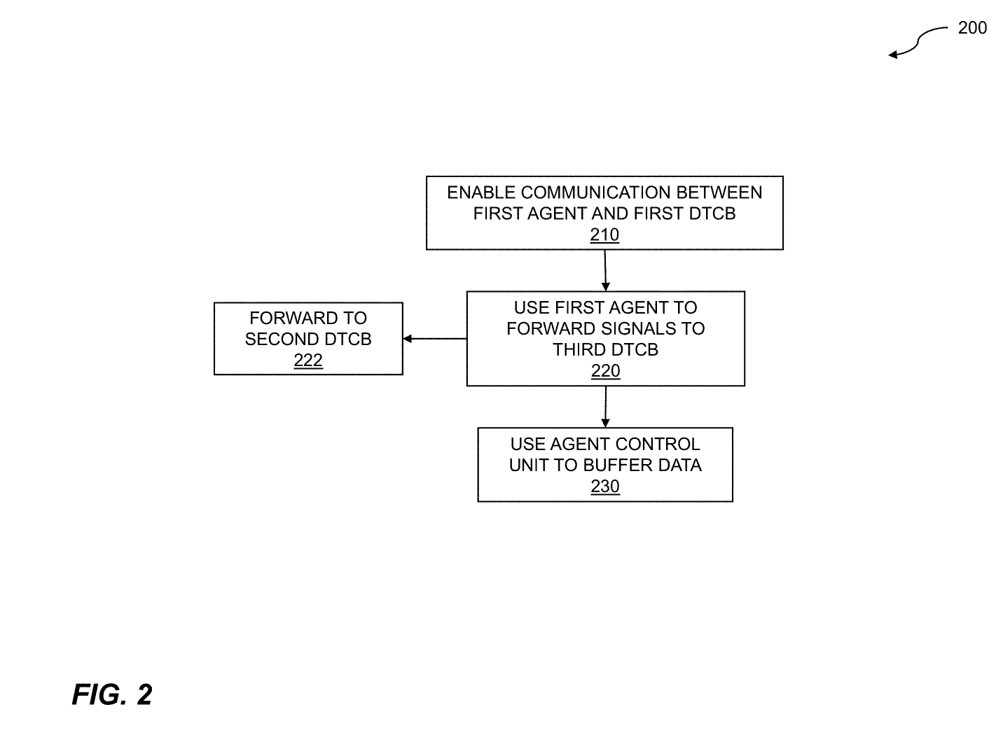

FIG. 2 is a flow diagram for inter-agent communication. Agents can be parts of a data flow graph, where the data flow graph can be implemented within a reconfigurable fabric. Clusters on the reconfigurable fabric, where the clusters can include processing elements, can be accessed to implement a logical operation. The logical operation can include a Boolean operation, a matrix operation, a tensor operation, and so on. Clusters can be provisioned for implementation of a first agent on the reconfigurable fabric, where the clusters provisioned for the first agent can include a first data transfer control block. Additional clusters can be provisioned for implementation of a second agent on the reconfigurable fabric, where the additional clusters provisioned for the second agent include a second data transfer control block. A logical operation can be performed using the first agent, and control information can be transferred from the first data transfer control block to the second data transfer control block.

Control or other information such as fire and done signals, data, and so on, can be exchanged between or among agents using inter-agent communication techniques. The agents that communicate can include agents from a data flow graph, agents from graph subsections resulting from partitioning the data flow graph, agents from different subsections of the data flow graph, etc. The agents that communicate can include agents that are resident or present within a reconfigurable fabric, agents that are partially resident, agents that are vacated from the reconfigurable fabric, etc. The exchange of control signals between agents can occur whether all or some of the agents are resident on the reconfigurable fabric. The flow 200 includes enabling communication between the first agent and the first data transfer control block (DTCB) 210 by a multi-agent DMA block. In some embodiments, storage is accomplished on chip while in other embodiments the storage is off chip. In some cases, storage off chip is utilized when data becomes too large to maintain locally. A multi-agent DMA (MAD) block can include a direct memory access (DMA) storage block, control, interfaces, and so on. The interfaces of the multi-agent DMA block can include interfaces for one or more of an input buffer read request, an output buffer write request, a done signal, and a fire signal. The MAD can include storage for signals such as the read, write, fire, or done signals, buffer records such as buffer identification data, buffer entry data, and the like. The buffer entry data can include last processed fire or done sequences, accumulated fire or done lengths, an agent index, buffer type or capacity, fire forwarding address or buffer ID, done forwarding address or buffer ID, etc.

The flow 200 includes using the first agent to forward data received by the first agent to a third data transfer control block 220 of a third agent. The third agent can be an agent within the same flow graph, subgraph, etc., as the first agent or the second agent. The third agent can be an intermediary agent between the first agent and the second agent when the first agent and the second agent are not in direct communication. In embodiments, the first agent forwards data it has received to the third agent for further forwarding to the second data transfer control block 222. The further forwarding by the third agent to the second agent can take place when both the third agent and the second agent are resident within the reconfigurable fabric. The flow 200 includes using an agent control unit to buffer data 230 incoming to the first agent. The buffering data incoming to the first agent can accomplish multiple purposes: converting between asynchronous data transfers and synchronous data transfers, handling differing data transfer rates, storing data when the first agent is not resident on the reconfigurable fabric, etc. In embodiments, a fourth agent can provide the data incoming to the first agent. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

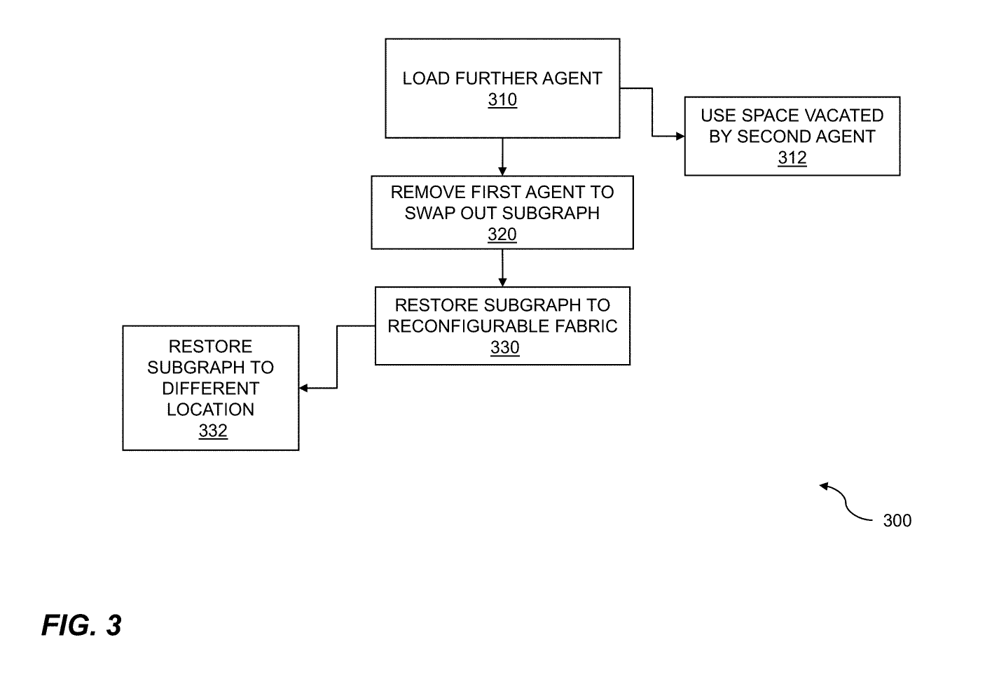

FIG. 3 is a flow diagram for subgraph swapping. Clusters on a reconfigurable fabric are accessed to implement a logical operation. Clusters are provisioned for implementation of a first agent and provisioned for implementation of a second agent. The provisioning for the agents can include provisioning for data transfer control blocks. In embodiments, the first agent or the second agent can be part of a data flow graph implemented within the reconfigurable fabric. The data flow graph can be partitioned into subgraphs, where the subgraphs can be allocated to clusters of the reconfigurable fabric. In embodiments, the size of the data flow graph exceeds the configurability of the reconfigurable fabric in a single loading, leading to re-provisioning or reallocating clusters of the reconfigurable fabric to subgraphs or agents. The allocating of the clusters includes dynamic reconfiguration using data transfer control.

The flow 300 includes loading a further agent 310. The further agent can be part of the data flow graph, can be part of a subgraph, and so on. The further agent can include an agent within the same subgraph as the first agent or the second agent, or can be an agent from another subgraph. In embodiments, the loading of the further agent can be performed using space vacated by the removing the second agent 312 or by using space vacated by another agent. The flow 300 includes removing the first agent in order to swap out a subgraph 320 that is part of the data flow graph. The first agent can be swapped out for a variety of purposes such as the first agent completing performance of a logical operation. The logical operation can include a Boolean operation, a matrix operation, a tensor operation, and the like. The subgraph of which the first agent is a part can be swapped for purposes including swapping out a lower priority subgraph for a higher priority subgraph. The second agent can be part of a second group of agents, where the second group of agents can be from a second subgraph. In embodiments, the second group of agents can be vacated from the reconfigurable fabric collectively as a group. The flow 300 includes restoring the subgraph into the reconfigurable fabric 330. The subgraph that was previously swapped out can be restored to the reconfigurable fabric after another subgraph, such as a higher priority subgraph, no longer has a higher priority, has completed execution, etc. In embodiments, the restoring can place the subgraph into a different location 332 in the reconfigurable fabric than it previously occupied prior to the swapping out of the subgraph. The different location can be a location that was previously un-provisioned, a location vacated by another subgraph etc.

In embodiments, agents can be loaded on a cluster or clusters within a certain system, and other agents can be loaded on a cluster or clusters within a different system. Various communication paths can provide data transfer between the systems, such as Ethernet, remote DMA (RDMA), PCIe, and so on. The communication paths can be synchronous or asynchronous or even a combination of both synchronous and asynchronous. The cluster within the different system can be a different type of cluster from the cluster on the certain system. The different type of cluster can be a coprocessor implemented using dissimilar agents on dissimilar systems. Various steps in the flow 300 may be changed in order, repeated, omitted, or the like without departing from the disclosed concepts. Various embodiments of the flow 300 can be included in a computer program product embodied in a non-transitory computer readable medium that includes code executable by one or more processors.

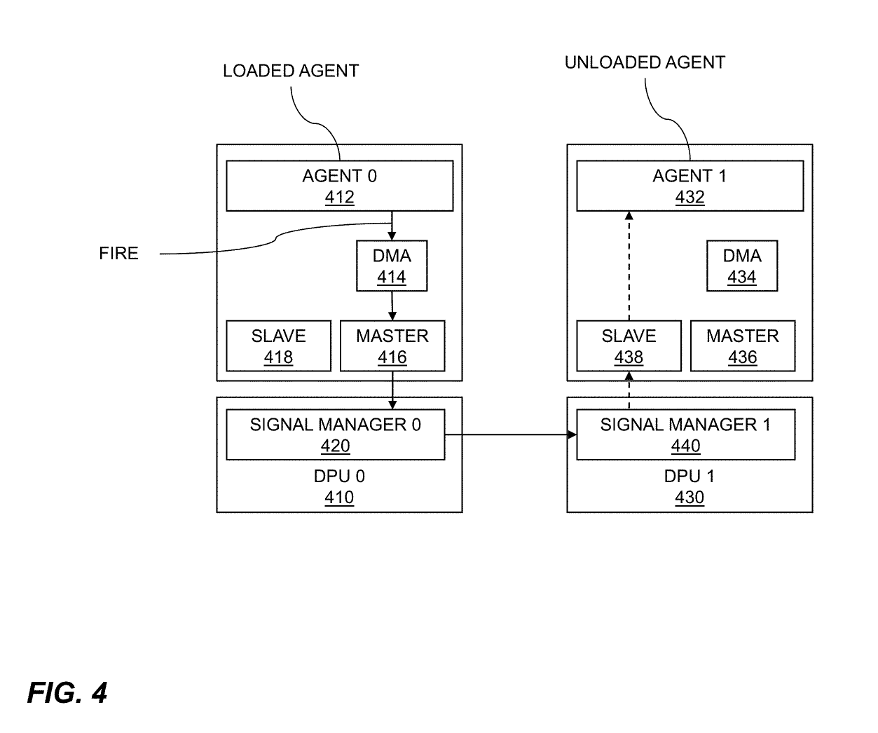

FIG. 4 illustrates signal manager communication with an unloaded agent. One or more agents can be part of a data flow graph, where a data flow graph can represent an operation such as a Boolean operation, a matrix operation, a tensor operation, and so on. A signal manager can handle the communications between or among the agents of the data flow graph. The signal manager communication can support dynamic reconfiguration using data transfer control. Clusters on a reconfigurable fabric are accessed to implement a logical operation. Clusters are provisioned for implementation of a first agent on the reconfigurable fabric, where the clusters provisioned for the first agent include a first data transfer control block. Additional clusters are provisioned for implementation of a second agent on the reconfigurable fabric, where the additional clusters provisioned for the second agent include a second data transfer control block. The logical operation is performed using the first agent, and control information is transferred from the first data transfer control block to the second data transfer control block.

A first data flow processing unit, DPU 0 410, can be in communication with a second unit, DPU 1 430. The DPU 0 can include a signal manager, such as signal manager 0 420 for Advanced eXtensible Interface (AXI™) master and slave interfaces. Also included in DPU 0 can be a master 416 and slave 418, a multi-agent direct memory access (DMA) unit 414, and clusters that can be provisioned for agents such as agent 0 412. The DPU 1 430 can include a signal manager 1 440, AXI™ interfaces master 436 and slave 438, a DMA unit 434, and clusters that can be provisioned for agents such as agent 1 432. The signal managers, such as signal manager 0 and signal manager 1, can remain on provisioned clusters within reconfigurable fabric, while agents such as agent 0 and agent 1 can be loaded (resident) or unloaded (vacated) based on the processing needs of the data flow graph. In example 400, agent 0 is resident and sends a fire signal to agent 1. The fire signal from agent 0 can be loaded into DMA 414, and forwarded to signal manager 0 via master 416. Signal manager 0 forwards the fire signal to signal manager 1. If agent 1 is resident within a reconfigurable fabric, then the fire signal from agent 0 can be transferred via slave 438 to agent 1. If agent 1 is not resident, then the fire signal from agent 0 can be stored by signal manager 1 until agent 1 can be loaded. When agent 1 is loaded, the fire signal from agent 0 can be transferred to agent 1 via slave 438. Agent 1 can proceed with performing one or more logical operations.

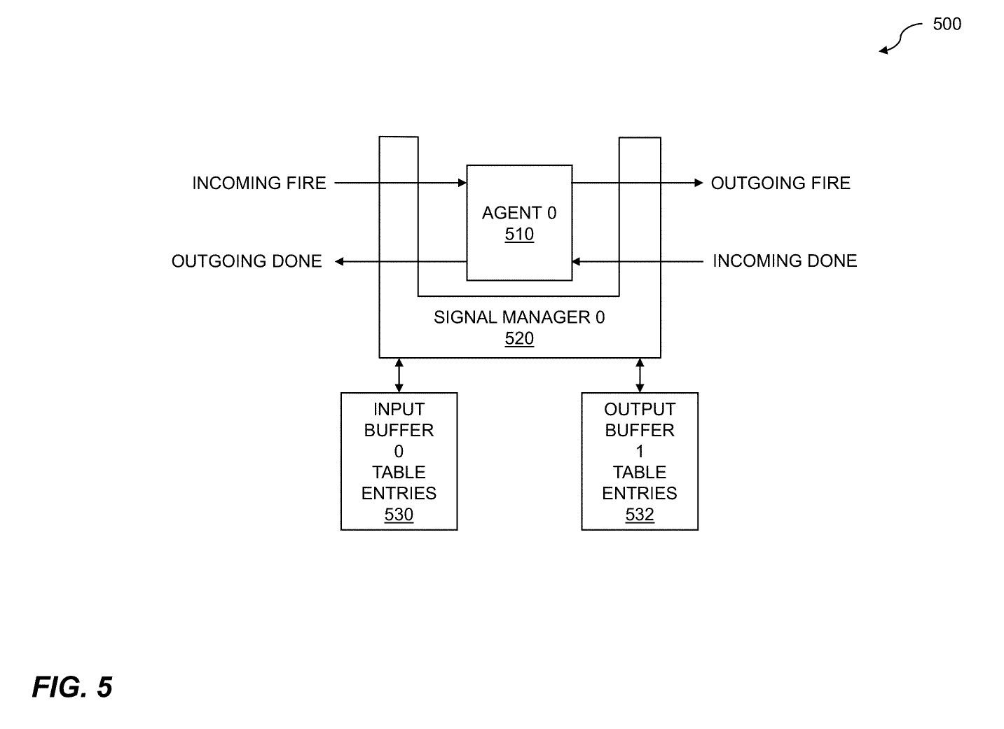

FIG. 5 shows signal manager fire/done forwarding. A signal manager can be associated with an agent and can be used to support delivery of fire signals to and done signals from the agent. An example signal manager for managing forwarding of fire signals and done signals for an agent is shown 500. A fire signal is sent from an agent (source) to another agent (target) to indicate that data such as tensors, matrices, etc., is ready for processing. The handling of fire signals and done signals by a signal manager supports dynamic reconfiguration using data transfer control. The target agent may be resident or partially resident on a reconfigurable fabric, or may be vacant from the reconfigurable fabric. The signal manager can handle the fire and done signals whether or not the target agent is resident.

An agent, agent 0 510, can be associated with a signal manager, signal manager 0 520. An incoming fire signal can be received by the signal manager 0 and can be passed to agent 0. If agent 0 is not loaded at the time the fire signal is received, the fire signal can be stored, and agent 0 can be requested for loading. Agent 0 can generate or forward a fire signal such as an outgoing fire signal. The outgoing fire signal from agent 0 can indicate to one or more downstream agents that data from agent 0 is ready for processing by the one or more other agents. In embodiments, the outgoing fire signal is the forwarded incoming fire signal. Agent 0 can receive a done signal such as an incoming done signal. The incoming done signal can indicate that processing has been completed by one or more agents downstream from agent 0. Agent 0 can generate an outgoing done signal. When agent 0 completes a computation such as a Boolean operation, a matrix operation, a tensor operation, etc., a done signal can be generated. Agent 0 can also generate an outgoing done signal when processing by agents which are downstream from agent 0 has been completed. In embodiments, agent 0 can forward the incoming done signal to the outgoing done signal. The signal manager 0 can handle the outgoing done signal and can arrange for routing the outgoing done signal to the recipient agent.

A signal manager, such as signal manager 0 520, can be coupled to an input buffer, such as input buffer 0 530, or to an output buffer, such as output buffer 1 532. The input buffer 530 and the output buffer 532 can include table entries. The table entries of the input buffer and the table entries of the output buffer can include entries for input buffers, output buffers, and so on. If an output buffer is routed to more than one downstream agent, or forked, then a separate buffer entry is required for each downstream agent. An input buffer responds to an incoming fire signal. The input buffer can forward the fire signal to an associated local agent such as agent 0 510. The table entries for a fire signal can include a data flow processing unit (DPU) address, a signal manager designation, a signal manager fire address, data, and so on. The table entries for a done signal can include a DPU address, an agent designation, and agent done address, data, and the like.

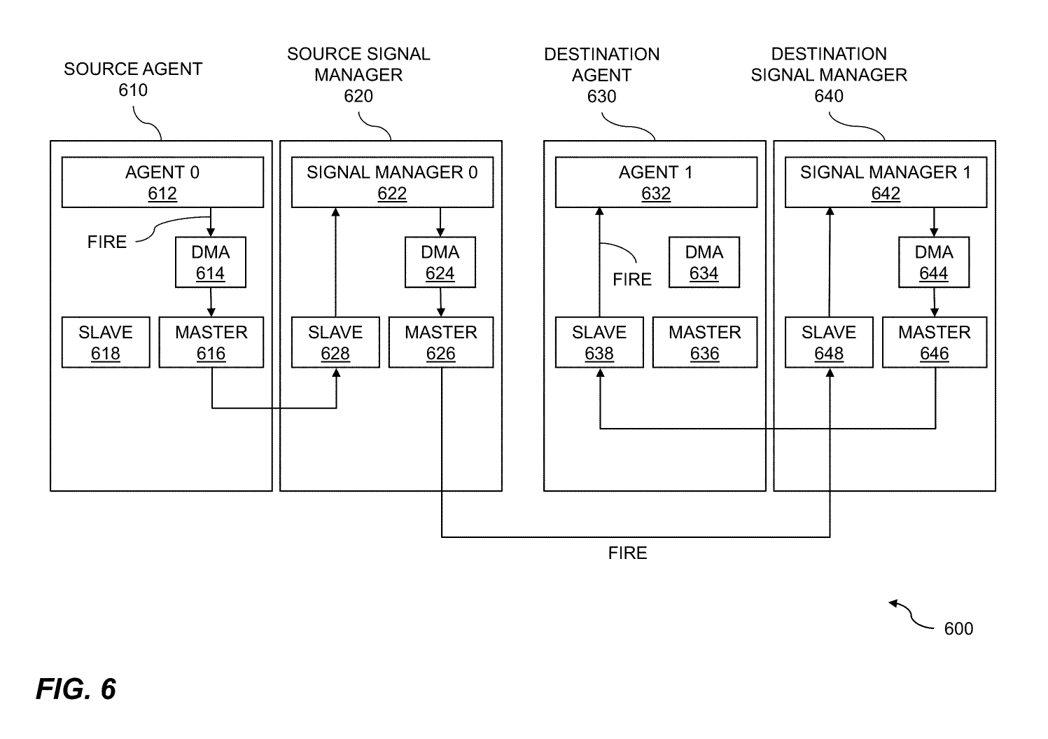

FIG. 6 illustrates sending a fire signal to a distant agent. A data flow graph can be implemented on a reconfigurable fabric, where the data flow graph can include one or more agents. Agents that are part of a data flow graph can communicate by exchanging signals such as a fire signal. A fire signal can indicate that data is ready for processing by an agent. Clusters on a reconfigurable fabric can be provisioned for implementation of the agents of the data flow graph. The clusters can include processing elements and other elements of a data flow processing unit (DPU). When the clusters that are provisioned for implementation of agents are not within the same DPU, then signals such as a fire signal can be sent from an agent on a first DPU to an agent on a second DPU. The sending of a fire signal from an agent to a distant agent can be used for dynamic reconfiguration using data transfer control.

A fire signal can be sent 600 from a source agent 610 to a destination agent 630. A first agent, agent 0 612 can initiate a fire signal. The fire signal can be stored in a multi agent direct memory access (DMA) storage element 614, also called MAD. The fire signal can be passed through a master interface 616, where the master interface can include an AXI™ master interface. In this example, the slave interface 618 is not included in the sending the fire signal from agent 0 to agent 1. Master interfaces can communicate with slave interfaces. Further, agents can communicate with signal managers. Master interface 616 can communicate with slave interface 628 of a source signal manager 620. The slave interface 628 can be an AXI™ slave interface. The slave 628 can pass the fire signal to the signal manager associated with agent 0, signal manager 0 622. The passing of the fire signal from agent 0 to agent 1 proceeds. Signal manager 0 can store the fire signal in DMA 624, where the DMA is associated with source signal manager 0. The fire signal proceeds through master interface 626 to slave interface 648, where slave interface 648 is associated with a destination signal manager 640. Signal manager 1 642 of destination signal manager 640 receives the fire signal from slave interface 648 and stores the fire signal in DMA 644. The fire signal proceeds through master interface 646 to slave interface 638 of the destination agent 630. The slave interface 638 is associated with the destination agent 1 632. The slave interface 638 passes the fire signal to agent 1 632. Agent 1 may begin processing following arrival of the fire signal. DMA 634 is not used for delivery of the fire signal from agent 0 to agent 1, but can be used for storing data, intermediate data, a fire signal for another agent, a done signal, and so on. When data is available in DMA 634, then the data may be transferred through master interface 636 to another agent, to a DMA, to other storage, and so on.

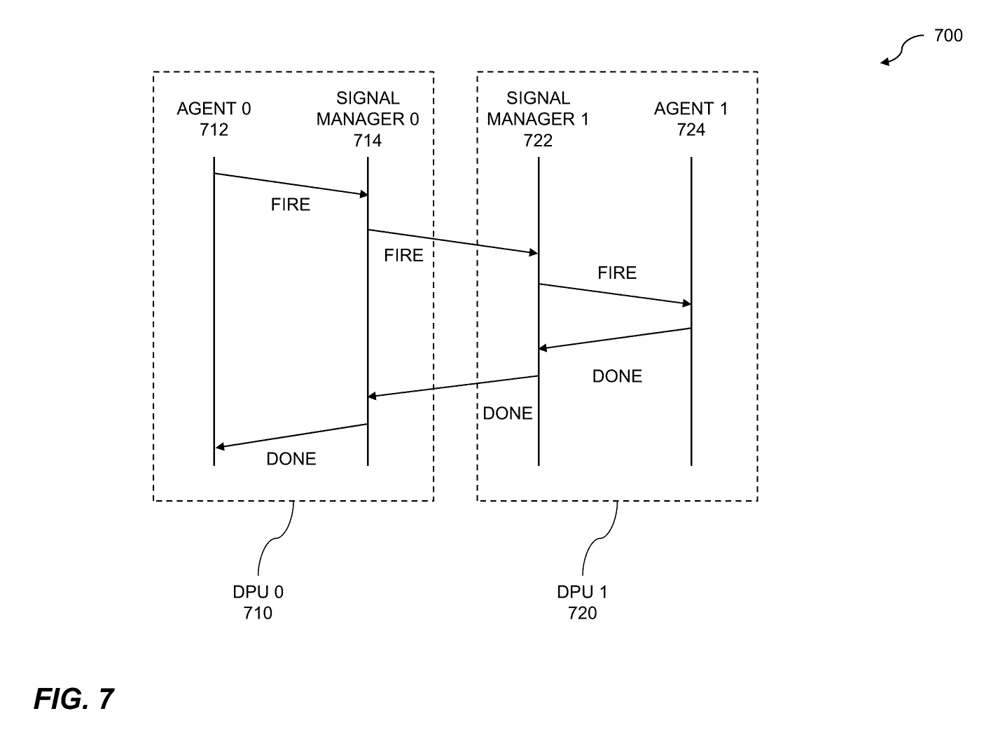

FIG. 7 shows a fire and done signal transfer between distant agents 700. Fire and done signals can be transferred between two agents or among multiple agents. A fire signal can indicate that data is available from an agent for processing one or more other agents. When the agents are not adjacent to or in direct communication with each other, then the transfer of the fire signals and the done signals can include transferring from an agent to a “distant” agent. The transferring of a fire signal and a done signal between an agent and a distant agent can be a basis for dynamic reconfiguration using data transfer control. The transferring of a fire signal or a done signal can include handling of the fire signal or done signal by one or more intermediate data flow processing units (DPUs).

An agent provisioned on a first DPU, DPU 0 710, initiates sending a fire signal from agent 0 712 to agent 1 724, where agent 1 is provisioned on a second DPU, DPU 1 720. The fire signal from agent 0 is handled by a first signal manager, signal manager 0 714. Signal manager 0 forwards the fire signal to another signal manager. The forwarding of the fire signal from one signal manager to another signal manager can be repeated until the fire signal arrives at a signal manager such as signal manager 1 722, which is associated with the target agent, agent 1. For simplicity of explanation, other intermediate signal managers of intermediate DPUs are not shown. The signal manager 1 sends the fire signal to agent 1 which can begin execution. When agent 1 has provided data to an output buffer associated with agent 1, and the data in the output buffer is available for processing by another agent, agent 1 can initiate a done signal. The done signal can be handled by a signal manager associated with agent 1, such as signal manager 1. Signal manager 1 forwards the done signal to another signal manager. As before, the forwarding of a signal such as the done signal from one signal manager to another signal manager can be repeated. When the done signal arrives at signal manager 0, signal manager 0 sends the done signal to agent 0. The arrival at agent 0 of the done signal from agent 1 can indicate that agent 1 has completed execution of an agent or agents and that output data is ready for further processing, forwarding, outputting, storing, etc.

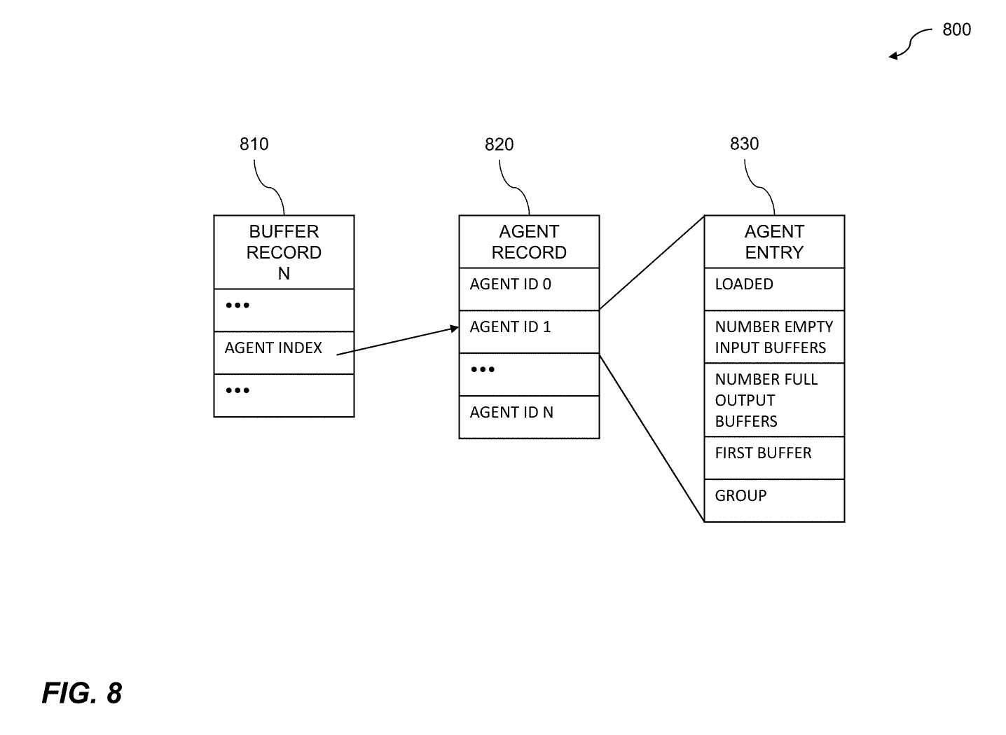

FIG. 8 illustrates determining agent information from a buffer entry. Agent information from a buffer entry 800 can be used to process one or more fire signals or one or more done signals, where the fire or done signals can be passed between or among agents on a reconfigurable fabric. The processing of the fire or done signals can be applied to dynamic reconfiguration using data transfer control. A fire signal or a done signal can be received by a signal manager from an agent. A buffer identification can be embedded in a fire signal or a done signal. The signal manager can examine the embedded buffer ID to obtain a data record for an associated data buffer. More than one buffer or buffer ID can be associated with a given agent. The agent can determine a particular agent by looking up the agent based on the agent index that is received. So, for a given fire signal or done signal, an agent index can be used to determine which buffer record should be referenced. A buffer record can include a buffer entry, where a buffer entry can include: a processed fire or done sequence, accumulated fire or done lengths, an agent index, a buffer type, a buffer capacity, a buffer valid indication, a fire forwarding address, a fire forwarding buffer ID, a done forwarding address, a done forwarding buffer ID, and so on.

A buffer identification can have an associated buffer record 810. The buffer record, such as buffer record N, can include one or more agent indices. An agent index from a buffer ID can be used to access an agent record 820. An agent record can include one or more agent IDs, and the agent IDs can refer to agents to be deployed on a reconfigurable fabric. The agents can be present on or vacant from the fabric. The agents can be part of a data flow graph that can be implemented on the reconfigurable fabric. In embodiments, the data flow graph can be larger than the reconfigurable fabric can allow in a single loading. The agent ID from the agent record can point to an agent entry 830. The agent entry can include information relating to that agent such as whether or not the agent is loaded, a number of empty agent input buffers, a number of full agent output buffers, a first buffer, a group number of ID, and so on.

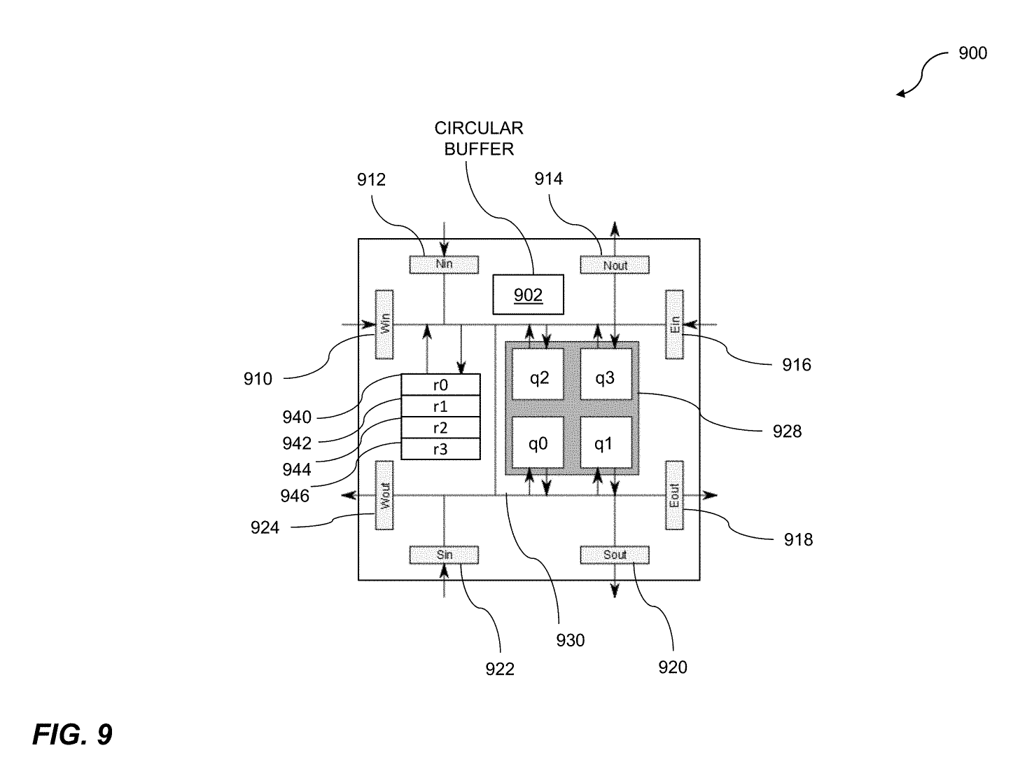

FIG. 9 shows a cluster for coarse-grained reconfigurable processing. The cluster for coarse-grained reconfigurable processing 900 can be used for dynamic reconfiguration using data transfer control. The dynamic reconfiguration can include accessing clusters on a reconfigurable fabric to implement a logical or other operation. The clusters on the reconfigurable fabric can include processing elements, switching elements, storage elements, etc. Clusters can be provisioned for a first agent, where the clusters that are provisioned include a first data transfer control block. Additional clusters can be provisioned for a second agent, where the second agent can include a second data transfer control block. The logical operation can be performed using the first agent, and control information can be transferred from the first data transfer control block to the second data transfer control block.

The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements—q0, q1, q2, and q3. The four processing elements can collectively be referred to as a “quad,” and can be jointly indicated by a grey reference box 928. In embodiments, there is intercommunication among and between each of the four processing elements. In embodiments, the circular buffer 902 controls the passing of data to the quad of processing elements 928 through switching elements. In embodiments, the four processing elements 928 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements—r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than to store the data in a register first, and then send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions—North, East, South, West, a switch register, one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination of both (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed to enter configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty signal can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

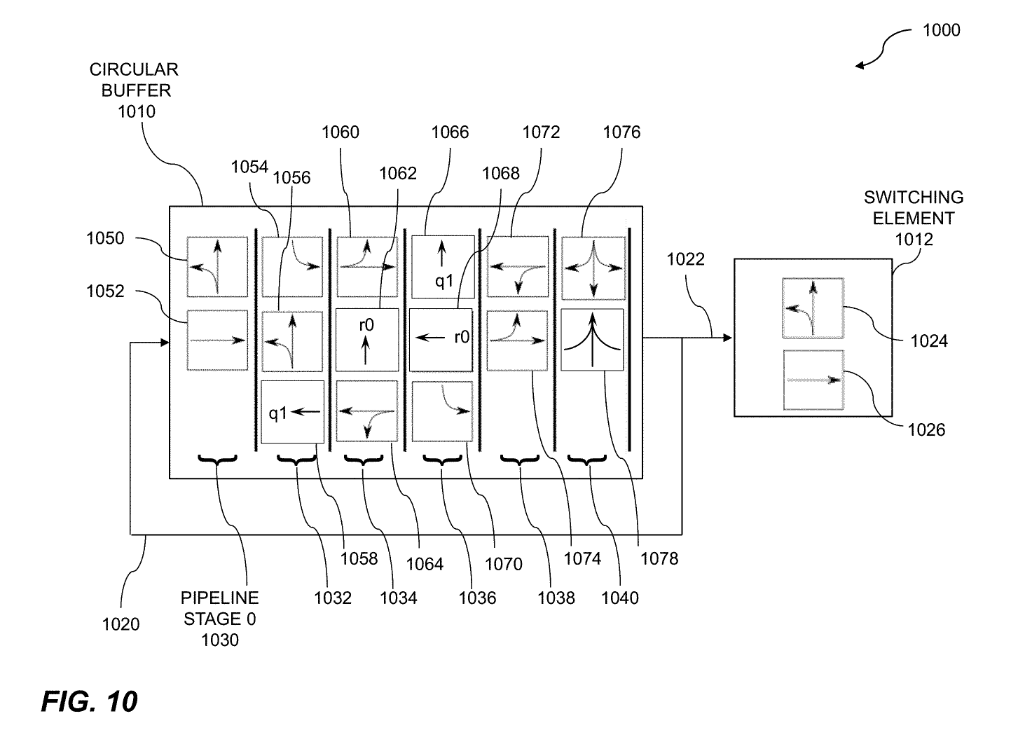

FIG. 10 shows a block diagram of a circular buffer. The circular buffer 1000 can include a switching element 1012 corresponding to the circular buffer. The circular buffer and the corresponding switching element can be used in part for dynamic reconfiguration using data transfer control. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the example 1000 shown, Pipeline Stage 0 1030 has an instruction depth of two instructions 1050 and 1052. Though the remaining pipeline stages 1-5 are not textually labeled in the FIG. 1000, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out on the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use preprocessing, such as by a compiler, to arrange the instructions in such a way that there are no collisions when the instructions are loaded into the circular buffer. Thus, the circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

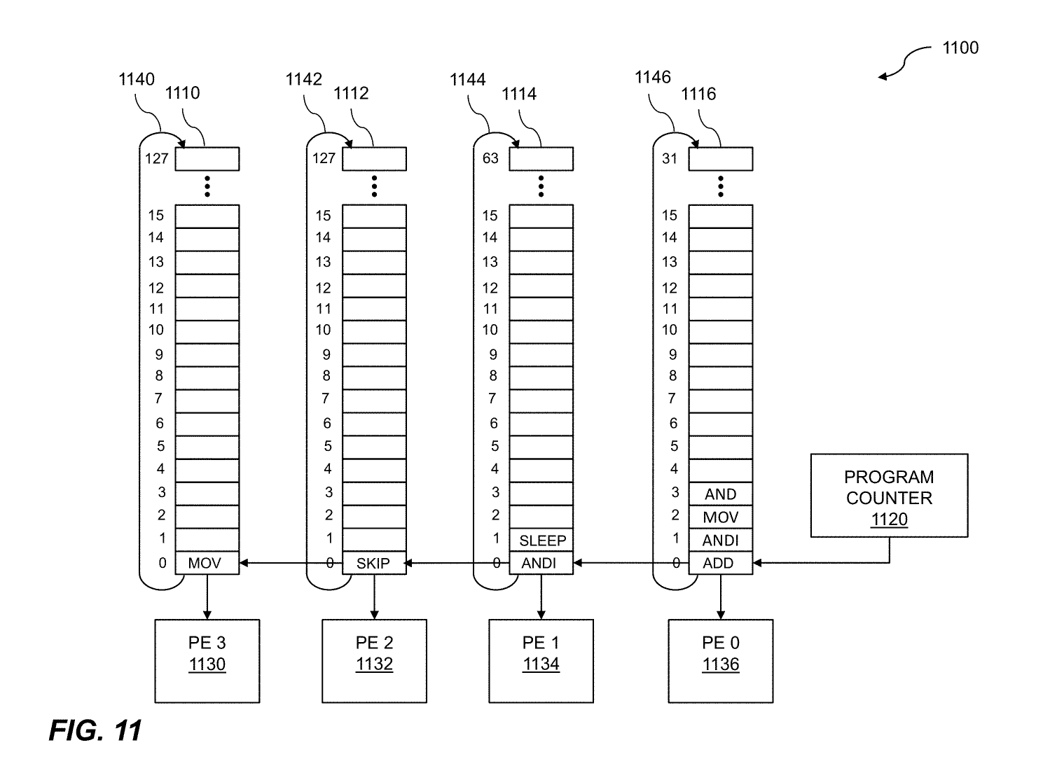

FIG. 11 illustrates a circular buffer and processing elements. A diagram 1100 indicates example instruction execution for processing elements. The processing elements can include a portion of or all of the elements within a reconfigurable fabric. The instruction execution can include instructions for dynamic reconfiguration using data transfer control. A circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1110 and 1112 have a length of 128 instructions, the circular buffer 1114 has a length of 64 instructions, and the circular buffer 1116 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, circular buffer 1110 contains a MOV instruction. Circular buffer 1112 contains a SKIP instruction. Circular buffer 1114 contains a SLEEP instruction and an ANDI instruction. Circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

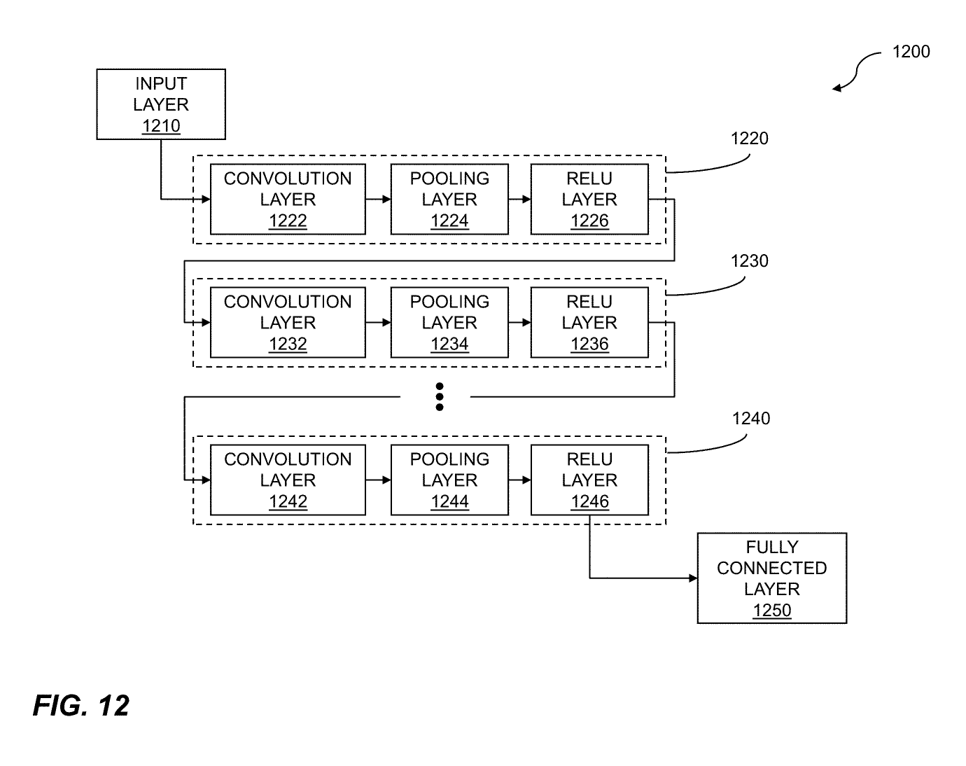

FIG. 12 shows a deep learning block diagram. The deep learning block diagram 1200 can include a neural network such as a deep neural network (DNN), a convolutional neural network (CNN), and so on. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform various operations such as logical operations. Deep learning can be applied to dynamic reconfiguration using data transfer control.

A deep learning block diagram 1200 is shown. The block diagram can include various layers, where the layers can include an input layer, hidden layers, a fully connected layer, and so on. In some embodiments, the deep learning block diagram can include a classification layer. The input layer 1210 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 1200, which can represent a network such as a convolutional neural network, can contain a plurality of hidden layers. While three hidden layers, hidden layer 1220, hidden layer 1230, and hidden layer 1240 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1220 can include convolution layer 1222, pooling layer 1224, and ReLU layer 1226; layer 1230 can include convolution layer 1232, pooling layer 1234, and ReLU layer 1236; and layer 1240 can include convolution layer 1242, pooling layer 1244, and ReLU layer 1246. The convolution layers 1222, 1232, and 1242 can perform convolution operations; the pooling layers 1224, 1234, and 1244 can perform pooling operations, including max pooling, such as data down-sampling; and the ReLU layers 1226, 1236, and 1246 can perform rectification operations. A convolutional layer can reduce the amount of data feeding into a fully connected layer. The block diagram 1200 can include a fully connected layer 1250. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processor can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

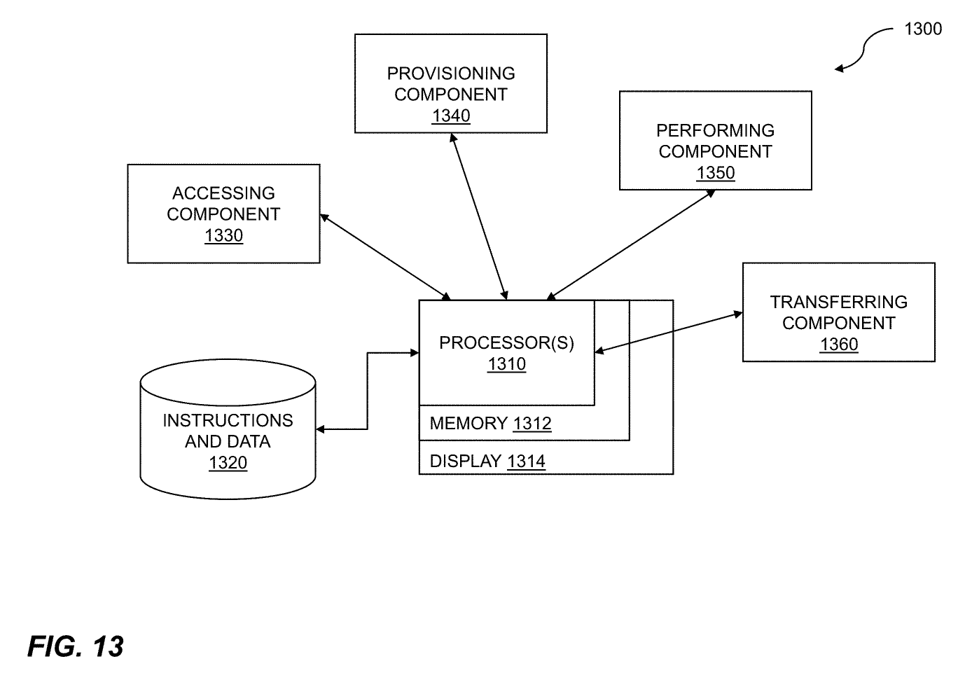

FIG. 13 is a system diagram for dynamic reconfiguration using data transfer control. The system 1300 can include one or more processors 1310 coupled to a memory 1312 which stores instructions. The system 1300 can include a display 1314 coupled to the one or more processors 1310 for displaying data, intermediate steps, instructions, and so on. In embodiments, one or more processors 1310 are attached to the memory 1312 where the one or more processors, when executing the instructions which are stored, are configured to: access a plurality of clusters on a reconfigurable fabric to implement a logical operation; provision one or more clusters from the plurality of clusters for implementation of a first agent on the reconfigurable fabric, wherein the one or more clusters provisioned for the first agent include a first data transfer control block; provision one or more additional clusters from the plurality of clusters for implementation of a second agent on the reconfigurable fabric, wherein the one or more additional clusters provisioned for the second agent include a second data transfer control block; perform the logical operation using the first agent; and transfer control information from the first data transfer control block to the second data transfer control block. In embodiments, the transferring control information from the first data transfer control block to the second data transfer control block occurs before the second agent is provisioned on the one or more additional clusters.

The system 1300 can include a collection of instructions and data 1320. The instructions and data 1320 may be stored in a database, one or more statically linked libraries, one or more dynamically linked libraries, precompiled headers, source code, flow graphs, kernels, agents, or other suitable formats. The instructions can include instructions for dynamic reconfiguration using data transfer control. The data can include unstructured data, matrices, tensors, layers and weights, etc. The instructions can include a static schedule for controlling one or more rotating circular buffers. The system 1300 can include an accessing component 1330. The accessing component 1330 can include functions, instructions, or code for accessing a plurality of clusters on a reconfigurable fabric to implement a logical operation. The logical operation can include a Boolean operation, a matrix operation, a tensor operation, and the like. The clusters on the reconfigurable fabric can include quads of elements such as processing elements. The reconfigurable fabric can further include other elements such as storage elements, switching elements, and the like.

The system 1300 can include a provisioning component 1340. The provisioning component 1340 can include functions and instructions for provisioning one or more clusters from the plurality of clusters for implementation of a first agent on the reconfigurable fabric, where the one or more clusters provisioned for the first agent include a first data transfer control block. The first agent can be divided into one or more partitions, where each partition can be assigned to one or more clusters. The first agent can be part of a data flow graph. In embodiments, the size of the data flow graph exceeds the configurability of the reconfigurable fabric in a single loading. The data transfer control block can include data, status information, and so on. The data transfer control block can include writer state, reader state, write offset and length, read offset and length, fire status, or done status, etc. The control block can include a signal manager, where the signal manager can manage fire signals, done signals, etc. The provisioning component can include functions and instructions for provisioning one or more additional clusters from the plurality of clusters for implementation of a second agent on the reconfigurable fabric, where the one or more additional clusters provisioned for the second agent include a second data transfer control block. The second agent can be part of a data flow graph, where the data flow graph of which the second agent is a part can be the same data flow graph of which the first agent is a part or a different data flow graph. The first data transfer control block or the second data transfer control block can have access to multi-agent direct memory access (MAD).

The system 1300 can include a performing component 1350. The performing component 1350 can include functions and instructions for performing the logical operation using the first agent. The logical operation can include a Boolean operation, a matrix operation, a tensor operation, etc. The performing component, which can include clusters on the reconfigurable fabric, can include clusters comprising quads of processing elements or other elements within the reconfigurable fabric. The system 1300 can include a transferring component 1360. The transferring component can include functions and instructions for transferring control information from the first data transfer control block to the second data transfer control block. The control information can include data or agent data information, fire status information, done status information, etc. In embodiments, the transferring control information from the first data transfer control block to the second data transfer control block can transpire before the second agent is provisioned on the one or more additional clusters. The transfer of control can initiate loading of the second agent onto the reconfigurable fabric. In embodiments, the first data transfer control block and the second data transfer control block are common. The transfer of control information from the first data transfer control block to the second data transfer control block can include transfer of control when one or other of the agents is present or vacant. In embodiments, the transferring can occur when the first agent is not present. The first agent may have been swapped out due to completing a task, due to a higher priority task taking precedence, etc. In other embodiments, the transferring can occur when the second agent is not present.

The system 1300 can include a computer program product embodied in a non-transitory computer readable medium for fabric reconfiguration, the computer program product comprising code which causes one or more processors to perform operations of: accessing a plurality of clusters on a reconfigurable fabric to implement a logical operation; provisioning one or more clusters from the plurality of clusters for implementation of a first agent on the reconfigurable fabric, wherein the one or more clusters provisioned for the first agent include a first data transfer control block; provisioning one or more additional clusters from the plurality of clusters for implementation of a second agent on the reconfigurable fabric, wherein the one or more additional clusters provisioned for the second agent include a second data transfer control block; performing the logical operation using the first agent; and transferring control information from the first data transfer control block to the second data transfer control block.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for fabric reconfiguration comprising:
accessing a plurality of clusters on a reconfigurable fabric to implement a logical operation;
provisioning one or more clusters from the plurality of clusters for implementation of a first agent on the reconfigurable fabric, wherein the one or more clusters provisioned for the first agent include a first data transfer control block;
provisioning one or more additional clusters from the plurality of clusters for implementation of a second agent on the reconfigurable fabric, wherein the one or more additional clusters provisioned for the second agent include a second data transfer control block;
performing the logical operation using the first agent; and
transferring control information from the first data transfer control block to the second data transfer control block.

2. The method of claim 1 wherein the transferring control information from the first data transfer control block to the second data transfer control block occurs before the second agent is provisioned on the one or more additional clusters.

3. The method of claim 1 wherein the first data transfer control block and the second data transfer control block are common.

4. The method of claim 1 wherein the transferring occurs when the first agent is not present.

5. The method of claim 1 wherein the transferring occurs when the second agent is not present.

6. The method of claim 1 wherein each data transfer control block comprises a signal manager.

7. The method of claim 6 wherein the signal manager contains a table of done and fire signals.

8. The method of claim 7 wherein the signal manager further includes FIFO pointers.

9-13. (canceled)

14. The method of claim 1 further comprising enabling communication between the first agent and the first data transfer control block by a multi-agent DMA block.

15. The method of claim 14 wherein the multi-agent DMA block includes interfaces for one or more of an input buffer read request, an output buffer write request, a done signal, and a fire signal.

16. The method of claim 1 further comprising using the first agent to forward data received by the first agent to a third data transfer control block of a third agent for further forwarding to the second data transfer control block.

17. The method of claim 1 further comprising using an agent control unit to buffer data incoming to the first agent.

18. The method of claim 17 wherein a fourth agent provides the data incoming to the first agent.

19. The method of claim 1 wherein each cluster from the plurality of clusters comprises a plurality of processing elements.

20. The method of claim 19 wherein the plurality of processing elements comprises a quad of processing elements.

21-22. (canceled)

23. The method of claim 1 wherein the first agent or the second agent is part of a data flow graph implemented within the reconfigurable fabric.

24. The method of claim 23 wherein the size of the data flow graph exceeds configurability of the reconfigurable fabric in a single loading.

25. The method of claim 24 further comprising loading a further agent using space vacated by removing the second agent.

26. (canceled)

27. The method of claim 24 further comprising removing the first agent in order to swap out a subgraph that is part of the data flow graph.

28. The method of claim 27 further comprising restoring the subgraph into the reconfigurable fabric.

29. The method of claim 28 wherein the restoring places the subgraph into a different location in the reconfigurable fabric than was previously occupied by the subgraph prior to the swapping out of the subgraph.

30-34. (canceled)

35. A computer program product embodied in a non-transitory computer readable medium for fabric reconfiguration, the computer program product comprising code which causes one or more processors to perform operations of:
accessing a plurality of clusters on a reconfigurable fabric to implement a logical operation;
provisioning one or more clusters from the plurality of clusters for implementation of a first agent on the reconfigurable fabric, wherein the one or more clusters provisioned for the first agent include a first data transfer control block;
provisioning one or more additional clusters from the plurality of clusters for implementation of a second agent on the reconfigurable fabric, wherein the one or more additional clusters provisioned for the second agent include a second data transfer control block;
performing the logical operation using the first agent; and
transferring control information from the first data transfer control block to the second data transfer control block.

36. A computer system for fabric reconfiguration comprising:
a memory which stores instructions;
one or more processors attached to the memory wherein the one or more processors, when executing the instructions which are stored, are configured to:
access a plurality of clusters on a reconfigurable fabric to implement a logical operation;
provision one or more clusters from the plurality of clusters for implementation of a first agent on the reconfigurable fabric, wherein the one or more clusters provisioned for the first agent include a first data transfer control block;
provision one or more additional clusters from the plurality of clusters for implementation of a second agent on the reconfigurable fabric, wherein the one or more additional clusters provisioned for the second agent include a second data transfer control block;
perform the logical operation using the first agent; and
transfer control information from the first data transfer control block to the second data transfer control block.
